(19) United States
(12) Patent Application Publication
(10) Pub. No.: US 2008/0181254 A1
(43) Pub. Date: Jul. 31, 2008

(54) Data transmission method

(75) Inventor: Kun-Hui Chuo, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/698,572

(22) Filed: Jan. 25, 2007

(51) Int. Cl. H04J 3/16

(52) U.S. Cl. 370/469

(57) ABSTRACT

A data transmission method applicable to a network data processing device and adapted to execute data transmission between transmission protocol layers of a network system includes creating in a driver a global pointer series-connected to information about a pending task, and creating a status variable indicating a current execution status of the pending task; setting quantity of threads and tasks to be executed; series-connecting the global pointer to information about a new task and awakening the waiting thread as soon as the new task is received by the driver; searching the global pointer from the beginning so as to identify and execute the executable tasks, switching the thread to the next executable task for execution upon completion of execution of one step of each of the executable tasks, allowing the thread to return to the waiting state upon completion of execution of the set quantity of the executable tasks.

### BACKGROUND OF THE INVENTION

1. Field of the Invention

The present invention relates to a data transmission method, and more particularly, to a data transmission method for use in a network data processing device.

2. Description of the Prior Art

With software/hardware functions of data processing devices, networking technology, and network structures developing and becoming more widely used, individuals, families, schools, enterprises, and government organs increasingly perform data processing and data transmission through a network. Network-based transmission of voluminous data is more common than it has ever been before.

Given increasingly great flow of network data transmission, the data processing devices configured to process the data, such as network servers, and network architecture-oriented file servers/storage servers have to perform data processing faster or store more data in order to handle the great workload fast.

The most immediate approach to handle a large amount of tasks is to enhance the hardware performance of the aforesaid data processing devices, using hardware of high speed or high capacity. However, doing so is not necessarily economical in the eyes of every user. In fact, optimal hardware performance of a data processing device mostly depends on the processing procedures provided by an application like a driver or an operating system in operation. Therefore, the industrial sector is inevitably concerned to improve the processing procedures with a view to enhancing hardware performance of the data processing devices.

Taking a storage server applicable to a network system as an example, the storage server is typically equipped with a plurality of RAID harddisk devices adapted to allow a network servo or terminal device connected thereto to perform network data access via the harddisk devices.

For instance, where a task (like the transmission of data packages) has to be sent from a network terminal device to the storage server through a network so as to be stored in the harddisk device, the task would be executed in the form of data transmission between protocol layers by means of a network task processing driver provided by the storage server, and then the task would be sent to the harddisk device for storage by means of a data bus of the storage server.

The prior art discloses single-threaded data transmission between a plurality of protocol layers, where a single thread executes a task that entails performing data transmission between the protocol layers in sequence according to the task requirement, and the thread has to execute any tasks one by one. A drawback of single-threaded execution is that failure of a task prevents the execution of any other tasks, resulting in a waste of system resources.

To overcome the drawback, the prior art discloses multi-threaded execution, where every task's entry into the storage server causes the driver to produce a thread for processing the task, and then the thread executes data transmission between the protocol layers in sequence according to the task requirement, and eventually, upon completion of the task, the thread is freed from the driver. However, owing to differences between the protocol layers in execution speed, an execution bottleneck keeps a thread waiting, and the driver swaps execution between the waiting thread and another program in order to prevent a waste of system resources. Excessive swapping does deteriorate data transmission efficiency and system performance, and so do a large number of threads.

Accordingly, an issue calling for urgent solution involves providing a data transmission method for making good use of system resources available to a network data processing device and speeding up the processing of network data transmission by the network data processing device without changing an existing hardware architecture of network data processing devices.

### SUMMARY OF THE INVENTION

In light of the aforesaid drawbacks of the prior art, it is a primary objective of the present invention to provide a data transmission method for making good use of system resources available to a network data processing device and speeding up network data transmission handled by the network data processing device.

In order to achieve the above and other objectives, the present invention discloses a data transmission method for use in a network data processing device. The data transmission method enables data transmission between transmission protocol layers of a network system to be executed. The data transmission method comprises the steps of: creating in a driver a global pointer mounted with and series-connected to information about every pending task, and creating in a data structure for the pending task a status variable indicating a current execution status of the pending task; setting quantity of the threads and quantity of executable tasks to be executed by the threads; series-connecting the global pointer to information about a new task and awakening the waiting thread as soon as the new task is received by the driver; searching all the pending tasks in the global pointer from the beginning so as to identify the executable tasks at an executable state and execute the executable tasks by making reference to the state variable and the set quantity of executable tasks, switching the thread to the next executable task for execution upon completion of execution of one step of each of the executable tasks, allowing the thread to stop and return to the waiting state upon completion of execution of the set quantity of the executable tasks.

In comparison with the prior art applicable to a network data processing device, the present invention discloses a data transmission method whereby data processing performance among various network data processing devices is adjusted in accordance with the set number of threads and the set number of tasks to be executed, thereby making good use of system resources available to the network data processing device and speeding up network data transmission handled by the network data processing device.

### BRIEF DESCRIPTION OF THE DRAWINGS

FIG. 1 is a flow chart of a data transmission method in accordance with the present invention; and

FIG. 2 is a schematic view of a global pointer for the data transmission method shown in FIG. 1.

### DETAILED DESCRIPTION OF THE PREFERRED EMBODIMENT

The following specific embodiment is provided to illustrate the present invention. Persons skilled in the art can readily gain an insight into other advantages and features of the present invention based on the contents disclosed in this specification.

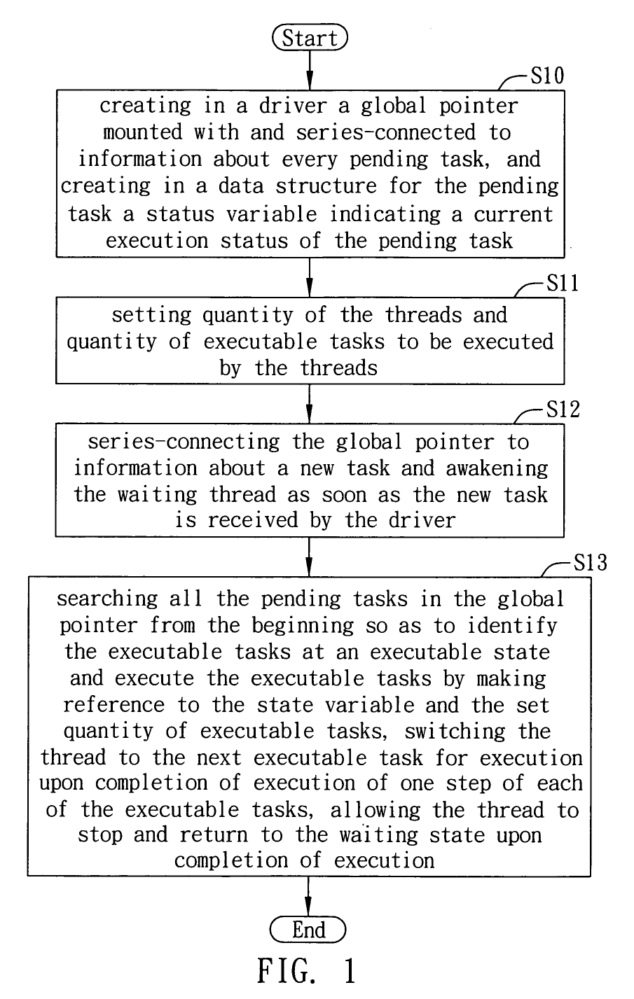

Referring to FIG. 1, which is a flow chart of a data transmission method in accordance with the present invention, the data transmission method of the present invention is for use in a network data processing device and enables at least one thread to execute tasks between transmission protocol layers of a network system. The network data processing device includes, but is not limited to, a network server, and a file server or storage server for use in a network architecture. The network data processing device of this embodiment is exemplified by a storage server.

The storage server is connected to a network by an optical fiber transmission cable. The network includes, but is not limited to, the Internet, intranet, and extranet. In other embodiments of the present invention, the storage server is also applicable to a wireless network architecture and connected to the aforesaid network via the wireless network architecture.

The storage server comprises a SCSI-compatible RAID composed of a plurality of harddisk devices, so as to enable data access between the RAID and the network data processing device (for example, a client end or a network server) connected to the storage server via the network.

The transmission protocol layers comprise first transmission protocol layers and second transmission protocol layers. The first transmission protocol layers are between the driver-dependent optical fiber transmission cable and a SCSI bus of the storage server. The second transmission protocol layers are between the SCSI bus and the RAID.

As shown in FIG. 1, step S10 comprises creating, in a driver installed in the network data processing device and adapted to execute data transmission between a data bus and an extranet, a global pointer mounted with and series-connected to information about every pending task, and creating, in a data structure for the pending task, a state variable indicating a current execution state of the pending task.

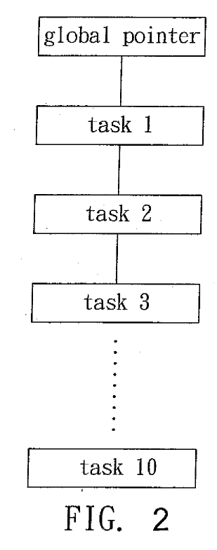

The driver of this embodiment drives a unit or module disposed in the network data processing device and adapted to execute network data transmission, and the unit or module is a networking chip built in the network data processing device or a networking card mounted on the network data processing device. The global pointer is created by the driver, and during operation of the driver the global pointer is temporarily stored in a storage device, such as a random access memory of the network data processing device, and the aforesaid harddisk device, such that the global pointer is mounted with and series-connected to information about every pending task. Every pending task is a data package for network transmission. Referring to FIG. 2, which is a schematic view of a structure of the global pointer, the global pointer points to ten pending tasks, namely task 1˜task 10.

By creating in a data structure of a pending task a state variable indicating a current execution state of the pending task, it means adding to a pending data package a state variable indicating a current execution state of the pending data package.

Step S11 comprises setting the quantity of the threads and the quantity of executable tasks, that is, the tasks at an executable state, are to be executed by the threads. As described above, the quantity of the threads is set to the number of CPUs of the storage server. In this embodiment, the storage server comprises four CPUs, thereby necessitating four threads, namely the first to fourth threads, corresponding to the four CPUs.

In this embodiment, as soon as a thread at a waiting state is awakened, the thread recognizes the global pointer immediately, searches all the pending tasks in the global pointer from the beginning so as to identify the executable tasks, that is, the tasks at an executable state, and executes the executable tasks. Referring to FIG. 2, the thread searches for the executable tasks, that is, the tasks at an executable state, from the beginning of the global pointer, that is, task 1.

Only one step of each of the executable tasks is executed by the thread. In this embodiment, the step is referred to as data package transmission between the first transmission protocol layers between the driver-dependent optical fiber transmission cable and a SCSI bus of the storage server, or data package transmission between the second transmission protocol layers between the SCSI bus and the RAID. Therefore, the set quantity of the tasks to be executed equals the number of steps of operation from awakening the thread to restoring the thread to the waiting state. In this embodiment, the quantity of the tasks to be executed is set to three.

Step S12 comprises the step of series-connecting the global pointer to information about a new task and awakening the waiting thread as soon as the new task is received by the driver. As described above, in this embodiment, as soon as the driver receives a plurality of data packages sent via the optical fiber transmission cable so as to be stored in the RAID of the storage server, the driver series-connects the data packages to the global pointer and awakens the thread by order of the packages' entry.

In step S13, the thread searches for and executes the executable tasks (the tasks at an executable state) from the beginning of the global pointer by making reference to the state variable and the quantity of executable tasks. Step S13 further involves the following: upon completion of execution of a step of an executable task, the thread switches to the next executable task for execution; and the thread stops and returns to the waiting state upon completion of execution of the set quantity of executable tasks. As described above, the four threads search for and execute executable tasks, that is, tasks at an executable state, by starting the search and execution with the first executable task (data package) series-connected to the global pointer, switch to the next executable task for execution upon completion of execution of a step of an executable task, stop and return to the waiting state upon completion of execution of the set quantity (i.e. three) of executable tasks, thereby freeing the occupied resources.

Assuming that, in this embodiment, a currently executable task 1 entails transmission between the first transmission protocol layers, and both a currently executable task 2 and a currently executable task 3 entail transmission between the second transmission protocol layers, and that the task 1 and the task 2 are being executed by the first and second threads respectively as opposed to the task 3, the consequence is: when awakened, the third thread starts to search for an executable task (i.e. a task at an executable state for the time being) for execution from the beginning of the global pointer; in other words, the search for an executable task begins with the task 1 and ends up with the execution of the found task 3. In addition, assuming that the first thread executes the executable task 1, finds and executes the executable task 5 and the executable task 7, the consequence is: upon completion of the execution of the executable task 7 by the first thread, the first thread returns to the waiting state, and the resources previously occupied by the first thread are freed, because the quantity of the tasks found executable in a search of the global pointer by the thread is set to three.

In conclusion, a data transmission method of the present invention enables adjustment of data processing performance among various network data processing devices in accordance with the set number of threads and the set number of tasks to be executed described in the aforesaid steps, thereby making good use of system resources available to the network data processing devices and speeding up network data transmission handled by the network data processing devices.

The aforesaid embodiment merely serves as the preferred embodiments of the present invention. The aforesaid embodiment should not be construed as to limit the scope of the present invention in any way. Hence, any other changes can actually be made in the present invention. It will be apparent to those skilled in the art that all equivalent modifications or changes made, without departing from the spirit and the technical concepts disclosed by the present invention, should fall within the scope of the appended claims.

What is claimed is:

1. A data transmission method used in a network data processing device comprising a driver for executing data transmission between a data bus and an extranet, the data transmission method allowing a task between transmission protocol layers of a network system to be executed by a thread, the data transmission method comprising the steps of:
creating in the driver a global pointer mounted with and series-connected to information about every pending task, and creating in a data structure for the pending task a state variable indicating a current execution state of the pending task;
setting quantity of the thread and quantity of executable tasks to be executed by the thread;
series-connecting the global pointer to information about a new task and awakening the waiting thread as soon as the new task is received by the driver; and
searching all the pending tasks in the global pointer from the beginning so as to identify the executable tasks at an executable state and execute the executable tasks by making reference to the state variable and the set quantity of executable tasks, switching the thread to the next executable task for execution upon completion of execution of one step of each of the executable tasks, allowing the thread to stop and return to the waiting state upon completion of execution of the set quantity of the executable tasks.

2. The data transmission method of claim 1, wherein the network data processing device comprises a unit driven by the driver and adapted to execute network data transmission, the unit being one of a networking chip built in the network data processing device and a networking card mounted on the network data processing device.

3. The data transmission method of claim 1, wherein the network data processing device comprises a module driven by the driver and adapted to execute network data transmission, the module being one of a networking chip built in the network data processing device and a networking card mounted on the network data processing device.

4. The data transmission method of claim 1, wherein the task is a data package.

5. The data transmission method of claim 1, wherein the network data processing device comprises at least one central processing unit (CPU), and the quantity of the threads is set to the number of the CPUs of the storage server.

6. The data transmission method of claim 1, wherein the network data processing device is one selected from the group consisting of a network server, a file server for use in a network architecture, and a storage server.
